(19) United States
(12) Patent Application Publication
(10) Pub. No.: US 2026/0367212 A1
(43) Pub. Date: Nov. 19, 2026

(54) POSITIONING REFERENCE SIGNAL INTEGRITY DETECTION AND QUANTIFICATION IN SIDELINK POSITIONING

(71) Applicant: Nokia Technologies Oy, Espoo (FI)

(72) Inventor: Stepan KUCERA, Munich (DE)

(21) Appl. No.: 19/142,958

(22) PCT Filed: Dec. 29, 2023
(86) PCT No.: PCT/EP2023/087979

§ 371 Date: Jun. 24, 2025

Related U.S. Application Data
(60) Provisional application No. 63/483,093, filed on Feb. 3, 2023.

(51) Int. Cl. G01S 5/02; H04B 17/318; H04L 5/00; H04W 92/18

(52) U.S. Cl. CPC G01S 5/0244; H04B 17/328; H04L 5/0048; H04W 92/18

(57) ABSTRACT

Various techniques are provided for a method including receiving, by a first terminal device and from a location management device, configuration information for positioning reference signal, PRS, integrity checking in connection with one or more second terminal devices configured to support positioning of a target terminal device, collecting, based on the configuration information, measurements of one or more PRS transmissions, and performing integrity checking on the one or more PRS transmissions based on corresponding received energy profile from the collected measurements of the PRS transmissions.

### CROSS-REFERENCE TO RELATED APPLICATION

This application is a national phase filing of International Application No. PCT/EP2023/087979, filed on Dec. 29, 2023, which claims priority to, and the benefit of, U.S. provisional application No. 63/483093, filed on Feb. 3, 2022, which is incorporated herein by reference in its entirety.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE) or terminal devices. LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include receiving, by a first terminal device and from a location management device, configuration information for positioning reference signal, PRS, integrity checking in connection with one or more second terminal devices configured to support positioning of a target terminal device, collecting, based on the configuration information, measurements of one or more PRS transmissions, and performing integrity checking on the one or more PRS transmissions based on corresponding received energy profile from the collected measurements of the PRS transmissions.

According to another example embodiment, a method may include communicating, by a location management device to a second terminal device, a position integrity configuration, receiving, by the location management device from the second terminal device, an integrity report including measurements associated with a first position reference signal, PRS, and a second PRS, and determining, by the location management device, whether or not the second PRS is a valid PRS based on the integrity report.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a network using sidelink positioning according to an example embodiment.

FIGS. 3A, 3B, and 3C are graph diagrams illustrating measured positioning reference signals according to an example embodiment.

FIGS. 4A and 4B are graph diagrams illustrating measured positioning reference signals according to an example embodiment.

FIGS. 5A and 5B illustrate signal flow diagrams according to an example embodiment.

FIG. 6 is a block diagram illustrating a method of verifying a positioning reference signal according to an example embodiment.

FIG. 7 is a block diagram illustrating another method of verifying a positioning reference signal according to an example embodiment.

FIG. 8 is a block diagram of a wireless station or wireless node (e.g., AP, BS, gNB, RAN node, relay node, UE or user device, terminal device, network node, network entity, DU, CU-CP, CU-CP, . . . or other node) according to an example embodiment.

### DETAILED DESCRIPTION

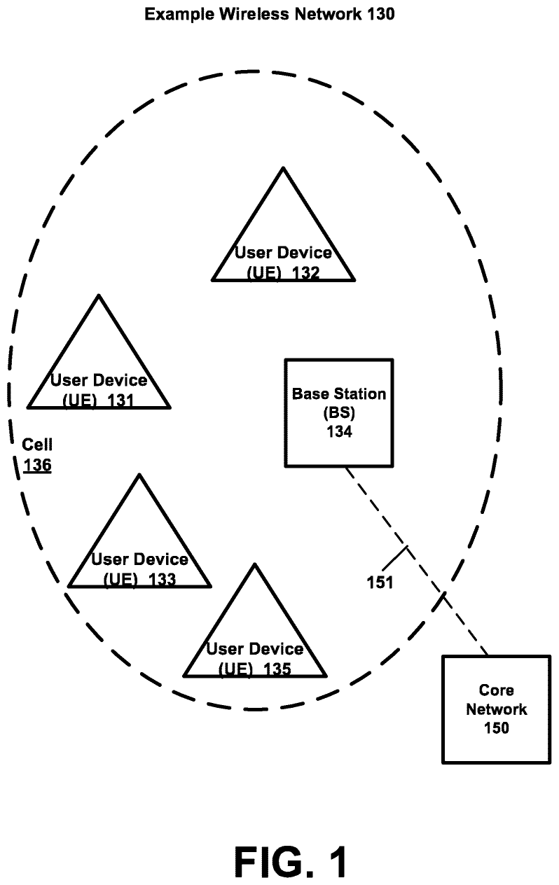

FIG. 1 is a block diagram of a wireless network 130 according to an example embodiment. In the wireless network 130 of FIG. 1, user devices 131, 132, 133 and 135, which may also be referred to as mobile stations (MSs), user equipment (UEs) or terminal devices, may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135.
Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the terminal device (e.g., UE)to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the terminal device (e.g., UE)that is received from a network or the core network, and/or forward data received from the terminal device (e.g., UE) to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a terminal device (e.g., UE) between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, terminal device, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)), 5G-Advanced, 6G, and the like may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) and 6G development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR) and 6G-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) and 6G systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), 6G, cm Wave, and/or mm Wave band networks, IoT, MTC, eMTC, mMTC, eMBB, URLLC, etc., or any other wireless network or wireless technology. These example networks, technologies or data service types are provided only as illustrative examples.

In 5G NR positioning, how to recognize that a legitimate PRS transmissions is being emulated or imitated by so-called spoofers is a known problem. Spoofing a PRS transmission can be due to a malfunction or with malicious intent. The problem with PRS spoofing is that a substantial error in the positioning of a target terminal device (e.g., UE) can be cause. In addition, PRS spoofing can entirely the positioning process. A signal transmitting device (e.g., an unidentified device transmitting a malicious PRS) or a malfunctioning sidelink terminal device (e.g., UE) can become a spoofing device in SL positioning, unlike in legacy Uu positioning where PRS are broadcast by network gNBs via their TRPs. Example implementations can be directed to 5G NR sidelink positioning scenarios where any sidelink terminal device (e.g., UE) can become a positioning anchor broadcasting SL PRS.

Example implementations can solve the aforementioned problems due to a spoofing device in SL positioning where the spoofing device is transmitting a PRS to a target device. Example implementations can include the use of an anchor terminal device (e.g., a sidelink UE) to measure the PRS that is identified as suspected of being a spoofing PRS. A device (e.g., a network entity, a BS, a DU, a CU a UE, and the like) including a location management function (LMF) can perform a validation decision associated with the PRS that is identified as suspected of being a spoofing PRS using PRS measurements made by the target terminal device (e.g., UE) and PRS measurements made by the anchor UE. The device including the LMF can be referred to as a location management device. Therefore, in example implementations described herein, a network entity, a BS, a DU, a CU a UE, and the like can be a location management device.

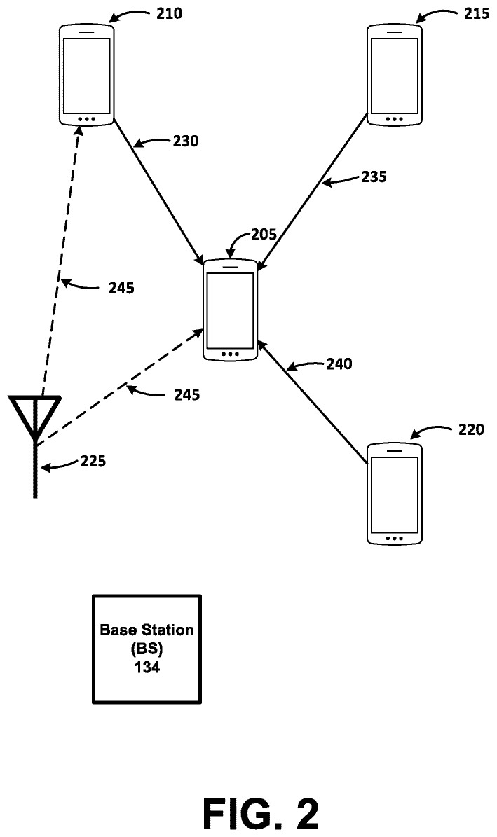

FIG. 2 is a diagram illustrating a network using sidelink positioning according to an example embodiment. As shown in FIG. 2 the network includes the BS 134, a UE 205, a UE 210, a UE 215, a UE 220, and a signal transmitting device 225 (sometimes called a device 225). The BS 134 can be a combination of devices. For example, the BS 134 can represent a BS and a core network device (or entity), the BS 134 can represent a BS and a control device (or entity), the BS 134 can represent a base station onboard a satellite, a satellite as a repeater and a terrestrial base station, and any other similar combination of network devices. A single device and/or the combination of devices can sometimes be referred to as a device, a system, and/or the like. The UE 205, the UE 210, the UE 215, and the UE 220 can be a user device, a terminal device, a user terminal, a mobile device, a stationary device, an internet of things (IoT) device, any wirelessly (or cellular) connected device, and/or the like.

In the Example implementation illustrated by FIG. 2, the UE 205 can be a target UE (e.g., a UE and/or terminal device) for which a location is to be determined). In the Example implementation illustrated by FIG. 2, the UE 210, the UE 215, and the UE 220 can be anchor UEs (e.g., UEs transmitting a PRS used in determining (or help determine) the location of the target UE). In an example implementation, a network entity can include the LMF. In this implementation, the UE 205, the UE 210, the UE 215, and the UE 220 can communicate with the network entity including the LMF via the base station 134. In an example implementation, a terminal device (e.g., UE) can include the LMF. In this implementation, the UE 205, the UE 210, the UE 215, and the UE 220 can communicate location information directly to the terminal device (e.g., UE) including the LMF. For example, the UE 220 can include the LMF. Therefore, the UE 205, the UE 210, and the UE 215 can communicate location information directly to the UE 220.

In the example of FIG. 2, UE 210 transmits a PRS 230, UE 215 transmits a PRS 235, and UE 220 transmits PRS 240. In addition, UE 205 (as the target UE) can measure the PRS 230, the PRS 235, and the PRS 240. The PRS measurements can be used in determining the location of UE 205.

Also shown in FIG. 2 is the signal transmitting device 225 or device 225 transmitting a spoof PRS 245. Spoof PRS 245 can be configure by device 225 to spoof, for example, the PRS 235. In other words, spoof PRS 245 can be spoofing the legitimate PRS 235 which can negatively impact the localization process of UE 205 (as a target UE). In an example implementation, UE 210 can also measure spoof PRS 245 and an LMF can use spoof PRS 245 as measured by UE 205 and spoof PRS 245 as measured by UE 210 to validate spoof PRS 245 (in this example spoof PRS 245 should be determined to be invalid).

Example implementations can determine whether or not a PRS is valid based on one of (or both of) two techniques. In a first technique, a device transmitting a spoof PRS (e.g., spoof of a legitimate PRS) cannot generate a spoof PRS that is time-aligned with the legitimate PRS transmission at both the target terminal device (e.g., UE) and an anchor terminal device (e.g., UE) because the anchor terminal device (e.g., UE and/or anchor UEs) are in distinct locations. In a second technique, the distance between a PRS source anchor terminal device (e.g., UE) and (any) other reference anchor UE(s) allows accurately estimating the PRS time of arrival (ToA) and validating the PRS measurements.

In the first technique if the device (e.g., device 225) transmitting the spoof PRS (e.g., spoof PRS 245) synchronizes the spoof PRS transmission with the legitimate PRS transmission at the target terminal device (e.g., UE 205), then at least one of the (multiple) anchor terminal devices (e.g., UE 210, UE 215, and UE 220) would observe two distinct PRS replicas because the device (e.g., device 225) transmitting the spoof PRS (e.g., spoof PRS 245) would be unable to synchronize with the anchor UEs as well due to the anchor UEs disjoint locations with respect to the target terminal device (e.g., UE 205). The device (e.g., device 225) transmitting the spoof PRS (e.g., spoof PRS 245) may synchronize the spoof PRS transmission with the legitimate PRS transmission at the target terminal device (e.g., UE 205) to, for example, reduce positioning accuracy while minimizing detection risk.

In the first technique if the device (e.g., device 225) transmitting the spoof PRS (e.g., spoof PRS 245) does not synchronize the spoof PRS transmission with the legitimate PRS transmission at the target terminal device (e.g., UE 205), then the target terminal device (e.g., UE 205) may be able to observe two distinct replicas of the same PRS. The device transmitting the spoof PRS not synchronizing the spoof PRS transmission is sometimes called blind PRS jamming.

In the second technique the location of positioning anchor UE(s) is known to the LMF and the server UE. Therefore, the expected time of arrival (ToA) of a given PRS when propagating from the source anchor of the PRS to (any) other anchor can be computed (as anchor distance/speed of light). The expected ToA of a PRS can be compared to the actual measured TOA. Furter, if the expected ToA is not within a pre-defined tolerance margin, an integrity alert can be triggered for the PRS.

Further, with either or both of the first technique and the second technique a signal power or signal energy associated with a measured PRS can help identify a spoof PRS transmission. For example, the legitimate PRS transmission can have an expected signal power or signal energy. Therefore, if a measured PRS transmission signal power or signal energy is higher or lower than expected signal power or signal energy (e.g., within a pre-defined threshold) an integrity alert can be triggered for the PRS. However, if a measured PRS transmission signal power or signal energy is below a pre-defined threshold signal power or signal energy the PRS transmission may be identified as noise (e.g., a reflection of some other PRS transmission).

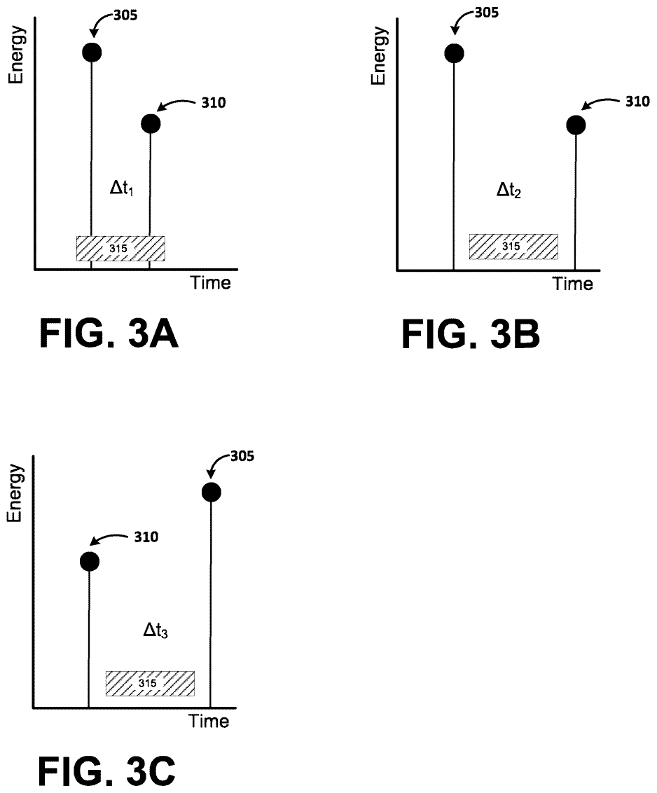

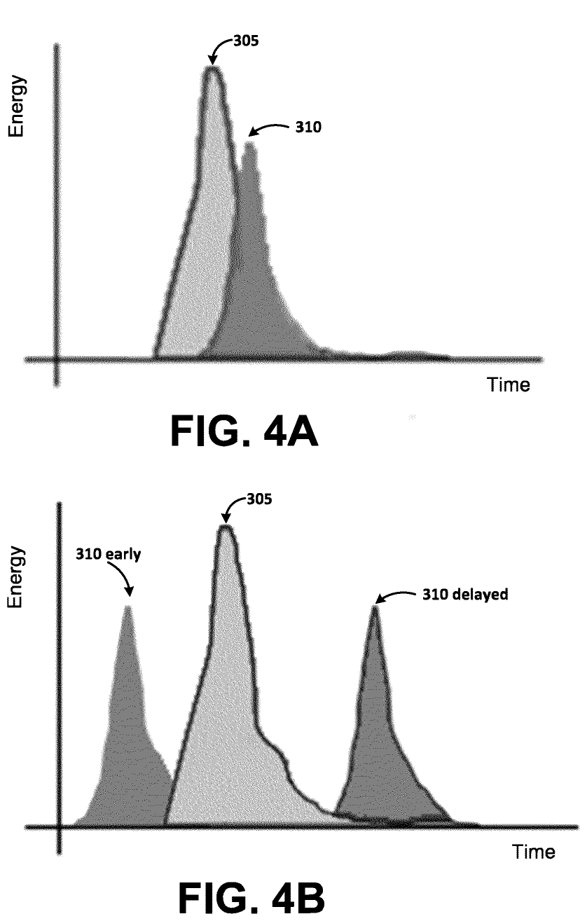

FIGS. 3A, 3B, and 3C are graph diagrams illustrating measured positioning reference signals according to an example embodiment. In the examples of FIGS. 3A, 3B, and 3C the measurements are illustrated as impulses for clarity purposes. However, measured positioning reference signals may have waveforms more like those shown below in FIGS. 4A and 4B. FIGS. 3A, 3B, and 3C illustrate a measured PRS 305 and a measured PRS 310. The measured PRS 305 can be associated with a legitimate PRS transmission (e.g., PRS 230, PRS 235, and PRS 240) and a measured PRS 310 can be associated with a spoof PRS (e.g., spoof PRS 245).

FIG. 3A can represent PRS 305 and PRS 310 being measured at a target terminal device (e.g., UE 205). In FIG. 3A PRS 305 and PRS 310 are measured with a time difference of Δt₁. The time difference Δt₁ is less than a separation tolerance 315. Therefore, FIG. 3A can illustrate a spoof PRS transmission overlapping with a legitimate PRS transmission. The overlapping PRS transmission may not be detectable by the target terminal device (e.g., UE 205). In other words, the target terminal device (e.g., UE 205) may not be able to measure, for example, a ToA. However, the target terminal device (e.g., UE 205) may determine that there is more than one peak. A PRS transmission with more than one peak may trigger an integrity alert for the PRS.

FIG. 3B can represent PRS 305 and PRS 310 being measured at an anchor terminal device (e.g., UE 210). In the example of FIG. 3B, the anchor terminal device (e.g., UE 210) can be further away from the source of PRS 310 as compared to the target UE. In FIG. 3B PRS 305 and PRS 310 are measured with a time difference of Δt₂. The time difference Δt₂ is greater than the separation tolerance 315. In addition, FIG. 3B can illustrate a spoof PRS transmission that is delayed with respect to a legitimate PRS transmission. The delayed PRS transmission may be detectable by the anchor terminal device (e.g., UE 210) because, for example, the time difference At2 is greater than the separation tolerance 315. In other words, the anchor terminal device (e.g., UE 210) may be able to measure, for example, a ToA. Therefore, the anchor terminal device (e.g., UE 210) can make measurements that can be used to validate a PRS.

FIG. 3C can represent PRS 305 and PRS 310 being measured at an anchor terminal device (e.g., UE 215). In the example of FIG. 3C, the anchor terminal device (e.g., UE 215) can be closer to the source of PRS 310 as compared to the target UE. In FIG. 3C PRS 305 and PRS 310 are measured with a time difference of Δt₃. The time difference Δt₃ is greater than the separation tolerance 315. In addition, FIG. 3C can illustrate a spoof PRS transmission that is early with respect to a legitimate PRS transmission. The early PRS transmission may be detectable by the anchor terminal device (e.g., UE 215) because, for example, the time difference Δt₃ is greater than the separation tolerance 315. In other words, the anchor terminal device (e.g., UE 215) may be able to measure, for example, a ToA. Therefore, the anchor terminal device (e.g., UE 215) can make measurements that can be used to validate a PRS.

FIGS. 4A and 4B are graph diagrams illustrating measured positioning reference signals according to an example embodiment. FIGS. 4A and 4B illustrate more typical measured PRS waveforms. FIG. 4A illustrates the spoof PRS transmission overlapping with a legitimate PRS transmission as described above with regard to FIG. 3A. FIG. 4B illustrates a spoof PRS transmission that is delayed and early with respect to a legitimate PRS transmission as described above with regard to FIG. 3B and FIG. 3C respectively.

Example implementations can use the first technique and the second technique described above to detect PRS spoofing and trigger an integrity alert for a PRS. For example, network entity including an LMF and/or a terminal device (e.g., UE) including an LMF (referred to as a server UE) can trigger a PRS validation check in response to the integrity alert. In an example implementation, a target terminal device (e.g., UE) uses PRS without a single sharp peak as trigger a trigger (e.g., as in FIG. 3A and FIG. 4A). In another example implementation, the network entity including an LMF and/or server UE can detect a measurement(s) mismatch and/or excessive error

A PRS to be validated can be identified and a suitable verification node can be selected. In an example implementation, the verification node can be an anchor UE. The Anchor terminal device (e.g., UE) may be selected randomly or based on RSRP (e.g., a weaker RSRP can be used to identify a non-collocated anchor. In another example implementation, the verification node can be a transmission reception point (TRP). In another example implementation, the verification node can have a common synchronization reference with a source anchor of the PRS to be validated (e.g., the PRS selected for validation).

The network entity including the LMF and/or server UE can configure integrity verification measurements by sending configuration data. In an example implementation, the configuration data can identify the PRS to be validated. The selected PRS can be marked in the configuration data using a binary flag indicating selection for a validation check. In another example implementation (or in addition), the configuration data can further include information related to distance between PRS source anchor and selected verification node (e.g., absolute locations or distance). In another example implementation (or in addition), the configuration further can further include an offset with respect to a common synchronization reference (e.g., a timing advance).

In another example implementation (or in addition), the configuration further can further include an indication of integrity evaluation criterion. An anchor terminal device (e.g., UE) selected in the validation process can be configured to collect measurements of the selected PRS and can evaluate PRS integrity based the criterion. In an example implementation, the criterion can be based on the evaluation of a single PRS energy or power peak. In another example implementation (or in addition), the criterion can be based on a comparison of PRS time of arrival (ToA) with an expected ToA. The expected ToA can be calculated as a distance between a source anchor and a verification anchor. ToA may be computed by accounting for an offset with respect to the reference clock of a common synchronization source (e.g., a timing advance).

The verification anchor terminal device (e.g., UE) can report to the network entity including the LMF and/or the server UE the result of an integrity verification in report data. In an example implementation, the report data can include a binary flag indicating success or failure of integrity check for a given PRS. A measurement report associated with selected PRS can be marked by the binary flag. In another example implementation, network entity including the LMF and/or the server UE can be configured to determine the success or failure of integrity check for a given PRS and the measurement report can include measurement data. The network entity including the LMF and/or the server UE can be configured to update the positioning process based on the integrity verification (e.g., in case of failure, reconfigures impacted PRS and/or source anchor UE).

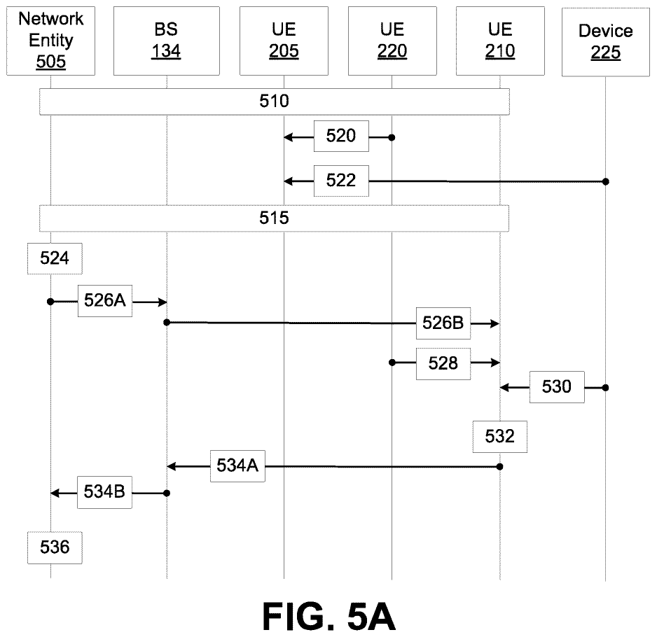

FIGS. 5A and 5B illustrate signal flow diagrams according to an example embodiment. FIG. 5A is a signal flow diagram according to an example embodiment. As shown in FIG. 5A, a network can include a network entity 505 (e.g., a location management device, a LMF, location server, and/or sensing server), the BS 134, the UE 205, the UE 210, the UE 220, and the signal transmitting device 225 (sometimes called device 225). In an example implementation, the network entity 505 can communicate with the UE 205, the UE 210, and the UE 220 via BS 134. The BS 134 can be a combination of devices. For example, the BS 134 can represent a BS and a core network device (or entity), the BS 134 can represent a BS and a control device (or entity), the BS 134 can represent a base station onboard a satellite, a satellite as a repeater and a terrestrial base station, and any other similar combination of network devices. A single device and/or the combination of devices can sometimes be referred to as a device, a system, and/or the like. The UE 205, the UE 210, and the UE 220 can be a user device, a terminal device, a user terminal, a mobile device, a stationary device, an internet of things (IoT) device, any wirelessly (or cellular) connected device, and/or the like.

In block 510, assistance data can be communicated through the network. The assistance data can be generated and communicated by the network entity 505 and/or UE 205, UE 210, UE 215, and/or UE 220 as the server UE. In block 520 a PRS is generated by the UE 220 and transmitted. Then the UE 205 (as the target terminal device) receives and measures the PRS transmitted by the UE 220. In block 522 the device 225, as a signal transmitting device, generates a spoof PRS. The spoof PRS generated by the device 225 can be configured to spoof the PRS transmitted by the UE 220. Then the UE 205 (as the target terminal device) receives and measures the spoof PRS transmitted by the device 225.

In block 515, a network node triggers a positioning integrity check. The positioning integrity check can be triggered by the target terminal device (e.g., UE) that observes unsharp profile of the received PRS without any (single) distinct peak, or by the network entity including the LMF and/or the server UE in case excessive error of one PRS with respect to other measurements. In other words, in block 515 the positioning integrity check can be triggered by the UE 205 (as the target terminal device), the network entity 505 (as the location management device) and/or any of UE 205, UE 210, UE 215, and/or UE 220 as the server UE.

In block 524, the network entity 505 (as the location management device) determines that the PRS is to be validated and that UE 210 is selected as the terminal device (e.g., UE) to make PRS validation measurements. The network entity 505 can generate configuration data associated with the PRS validation. The network entity 505 can communicate (e.g., wirelessly communicate) a message (block 526A) that is received by the BS 134. The BS 134 can communicate (e.g., wirelessly communicate) a message (block 526B) that is received by the UE 210. In this implementation, the message is generated by the network entity 505 and communicated to the UE 210 via the BS 134. The message can include configuration data generated by the network entity 505. The configuration data can identify the PRS selected for an integrity validation. For example, the selected PRS can be marked in (e.g., retransmitted, updated, and/or the like) assistance data by a raised binary flag. The configuration data can also include information related to distance between PRS source anchor and selected verification node (e.g., absolute locations or the distance). This information may be available via the initial assistance data distribution. The configuration data may also include information on the offset with respect to common synchronization reference (e.g., timing advance in case TRP is chosen as verification anchor). In addition, the configuration data may include an indication of integrity evaluation criterion.

In block 528 a PRS is generated by the UE 220 and transmitted. Then, the UE 210 (as the verification anchor terminal device) receives and measures the PRS transmitted by the UE 220. In block 530 the device 225, as a signal transmitting device, generates a spoof PRS. The spoof PRS generated by the device 225 can be configured to spoof the PRS transmitted by the UE 220. Then the 210 (as the verification anchor terminal device) receives and measures the spoof PRS transmitted by the device 225.

In block 532 the UE 210 (as the verification anchor UE) can be configured to collect the measurements of the selected PRS and evaluates PRS integrity based on the criterion. The criterion can be based on detecting a single clear PRS peak in the received energy profile. Alternatively, the criterion can compare the measured PRS time of arrival with the expected time of arrival. The expected time of arrival van be calculated from the distance between source anchor and verification anchor (distance/speed of light hardware propagation delay (if known)). The expected time of arrival may be computed by accounting for an offset with respect to the reference clock of a common synchronization source (e.g., timing advance) at both the UE 220 and the UE 210 (as the verification anchor terminal device). The difference can be added to a value corresponding to distance/speed of light-hardware propagation delay.

The UE 210 can communicate (e.g., wirelessly communicate) a message (block 534A) that is received by the BS 134. The BS 134 can communicate (e.g., wirelessly communicate) a message (block 534B) that is received by the network entity 505. In this implementation, the message is generated by the UE 210 and communicated to the network entity 505 via the BS 134. The message can include the results of the integrity verification of the selected PRS. For example, the message can include report data. The report data can include a binary flag indicating the success or failure of the performed integrity verification for a the selected PRS. For example, the measurement report associated with selected PRS can be marked by a binary flag. In block 536 the network entity 505 can perform a positioning process update based on the results of the integrity verification of the selected PRS.

FIG. 5B is a signal flow diagram according to an example embodiment. In the example of FIG. 5B a terminal device (e.g., UE) is the location management device (e.g., a server UE), whereas in the example of FIG. 5A the network entity 505 is the location management device. In FIG. 5B many blocks are the same as in FIG. 5A and will not be discussed for the sake of brevity.

In block 538, the UE 220 (as the location management device) determines that the PRS is to be validated and that UE 210 is selected as the terminal device (e.g., UE) to make PRS validation measurements. The UE 220 can generate configuration data associated with the PRS validation. The UE 220 can communicate (e.g., wirelessly communicate) a message (block 540) that is received by the UE 210. The message can include configuration data generated by the UE 220. The configuration data can identify the PRS selected for an integrity validation. For example, the selected PRS can be marked in (e.g., retransmitted, updated, and/or the like) assistance data by a raised binary flag. The configuration data can also include information related to distance between PRS source anchor and selected verification node (e.g., absolute locations or the distance). This information may be available via the initial assistance data distribution. The configuration data may also include information on the offset with respect to common synchronization reference (e.g., timing advance in case TRP is chosen as verification anchor). In addition, the configuration data may include an indication of integrity evaluation criterion.

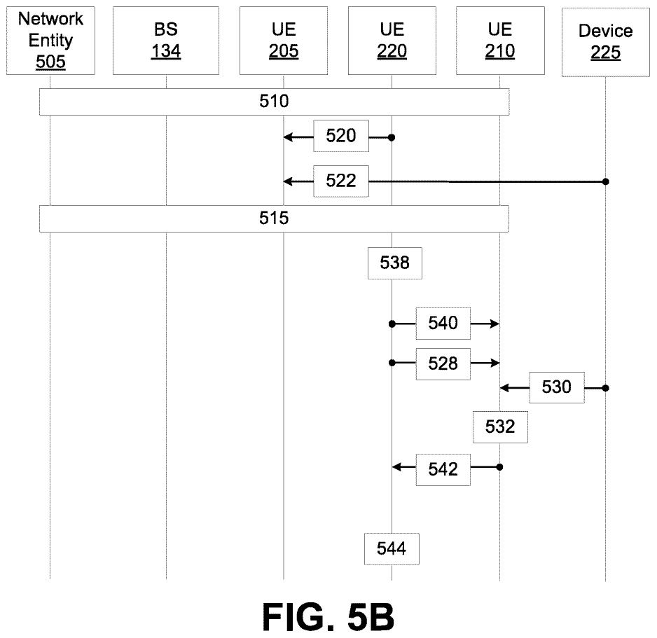

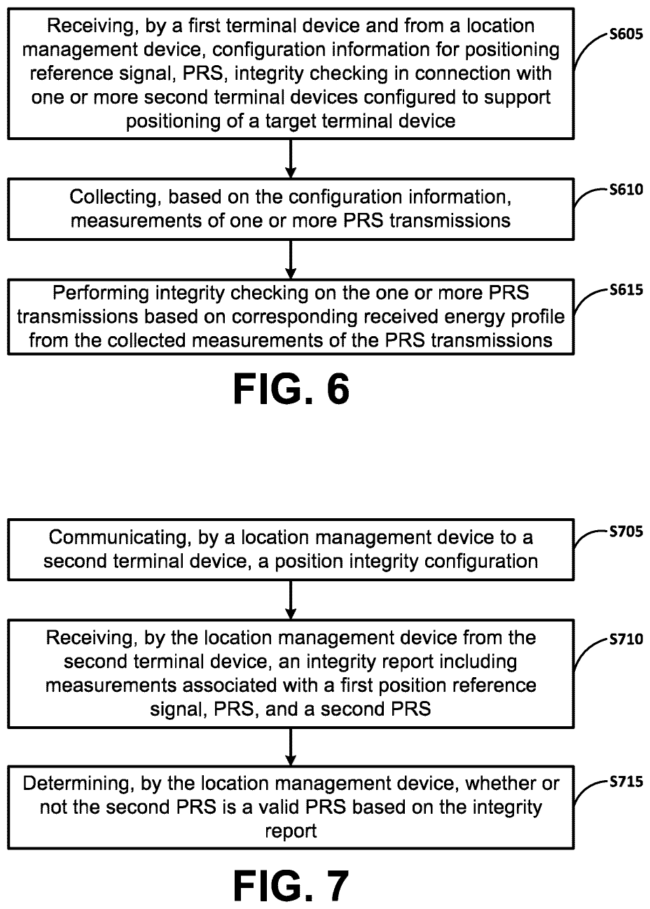

The UE 210 can communicate (e.g., wirelessly communicate) a message (block 542) that is received by the UE 220. The message can include the results of the integrity verification of the selected PRS. For example, the message can include report data. The report data can include a binary flag indicating the success or failure of the performed integrity verification for a the selected PRS. For example, the measurement report associated with selected PRS can be marked by a binary flag. In block 544 the UE 220 can perform a positioning process update based on the results of the integrity verification of the selected PRS.
Example 1. FIG. 6 is a block diagram of a method of verifying a PRS according to an example embodiment. As shown in FIG. 6, in step S605 receiving, by a first terminal device and from a location management device, configuration information for positioning reference signal, PRS, integrity checking in connection with one or more second terminal devices configured to support positioning of a target terminal device. In step S610 collecting, based on the configuration information, measurements of one or more PRS transmissions. In step S615 performing integrity checking on the one or more PRS transmissions based on corresponding received energy profile from the collected measurements of the PRS transmissions.
Example 2. The method of Example 1 can further include determining, by the first terminal device, whether or not the one or more PRS transmissions are from the one or more second terminal devices by evaluating the corresponding received energy profile from the collected measurements of the PRS transmissions.
Example 3. The method of Example 1 or Example 2, wherein the first terminal device and the one or more second terminal devices can be anchor terminal devices configured to support the positioning of the target terminal device.
Example 4. The method of Example 3 can further include generating, by the first terminal device, an integrity report comprising outcomes of the integrity checking and transmitting, to the location management device, the integrity report.
Example 5. The method of Example 1, wherein the collecting of the measurements of the one or more PRS transmissions can include measuring, by the first terminal device, a first PRS associated with one of the one or more second terminal devices identified in the configuration information and measuring, by the first terminal device, a second PRS associated with one of the one or more second device, the method can further include generating, by the first terminal device, an integrity report associated with a target terminal device based on the first PRS and the second PRS.
Example 6. The method of Example 5, wherein the second PRS can be a replica of the first PRS.
Example 7. The method of any of Example 1 to Example 6, wherein the location management device can be located in a network device, the method can further include communicating, by the first terminal device to the network device, the integrity report and receiving, by the first terminal device from the location management device, a verification report associated with the target terminal device, wherein the verification report indicates whether or not the second PRS is a valid PRS.
Example 8. The method of any of Example 1 to Example 6, wherein the location management device can be located in a network device, the method can further include communicating, by the first terminal device to the network device, the integrity report and receiving, by the first terminal device from the location management device, at least one of an updated assistance configuration, reconfiguration data, and position instructions associated with the target terminal device.
Example 9. The method of any of Example 1 to Example 6, wherein the location management device can be located in a location server terminal device, the method can further include communicating, by the first terminal device to the location server terminal device, the integrity report and receiving, by the first terminal device from the location management device, a verification report associated with the target terminal device, wherein the verification report indicates whether or not the second PRS is a valid PRS.
Example 10. The method of any of Example 1 to Example 6, wherein the location management device can be located in the first terminal device, the method can further include determining, by the first terminal device, whether or not the second PRS is a valid PRS can be based on at least one of a distance in time between a power profile associated with the first PRS and a power profile associated with the second PRS, a distance in time between a local power maxima associated with the first PRS and a local power maxima associated with the second PRS, a distance in time between a global power maxima associated with the first PRS and a global power maxima associated with the second PRS, a distance in time between a predefined power value associated with the first PRS and a predefined power value associated with the second PRS, a distance in time between a predefined power derivative associated with the first PRS and a predefined power derivative associated with the second PRS, a time of arrival associated with at least one of the first PRS and the second PRS, a peak power associated with at least one of the first PRS and the second PRS, and an expected time of arrival associated with the first PRS.
Example 11. The method of any of Example 1 to Example 10, wherein the position integrity configuration can include at least one of a PRS to be checked, a distance between a target terminal device and an anchor terminal device, an offset with respect to common synchronization reference, and an integrity evaluation criterion, the PRS to be checked can be the first PRS, the target terminal device can be the target terminal device, and the anchor terminal device can be the first terminal device.
Example 12. The method of any of Example 1 to Example 11, wherein the integrity evaluation criterion can include at least one of a PRS peak power, a PRS peak power range, a PRS peak power delta, a PRS time of arrival, a PRS time of arrival window, a PRS time of arrival mask, and a PRS time of arrival delta.
Example 13. FIG. 7 is a block diagram of another method of verifying a PRS according to an example embodiment. As shown in FIG. 7, in step S705 communicating, by a location management device to a second terminal device, a position integrity configuration. In step S710 receiving, by the location management device from the second terminal device, an integrity report including measurements associated with a first position reference signal, PRS, and a second PRS. In step S715 determining, by the location management device, whether or not the second PRS is a valid PRS based on the integrity report.
Example 14. The method of Example 13, wherein the determining of whether or not the second PRS is a valid PRS can include at least one of a time of arrival associated with at least one of the first PRS and the second PRS, a peak power associated with at least one of the first PRS and the second PRS, and an expected time of arrival associated with the first PRS.
Example 15. The method of Example 13 or Example 14 can further include triggering, by a location management device, a position integrity check associated with a first terminal device.
Example 16. The method of Example 15, wherein the triggering of the position integrity check can be based on at least one of detecting a PRS without a single peak power, at least two PRS peak powers within a time window, and at least two PRS peak powers greater than a threshold power and within a time window.
Example 17. The method of any of Example 13 to Example 16, wherein the position integrity configuration can include at least one of a PRS to be checked, a distance between a target terminal device and an anchor terminal device, an offset with respect to common synchronization reference, and an integrity evaluation criterion, the PRS to be checked can be the first PRS, the target terminal device can be the target terminal device, and the anchor terminal device can be the first terminal device.
Example 18. The method of Example 17, wherein the integrity evaluation criterion can include at least one of a PRS peak power, a PRS peak power range, a PRS peak power delta, a PRS time of arrival, a PRS time of arrival window, a PRS time of arrival mask, and a PRS time of arrival delta.
Example 19. The method of any of Example 13 to Example 18, wherein the location management device can be located in one of a network device, a base station, a distributed unit, a central unit, a transmission reception point, or a location server terminal device.
Example 20. The method of Example 19, wherein the location management device can be switched from one of the network device, the base station, or the transmission reception point to the location server terminal device based on a network being unavailable, or the location server terminal device to the network device, the base station, or the transmission reception point based on the network being available.
Example 21. A method can include any combination of one or more of Example 1 to Example 20.
Example 22. A non-transitory computer-readable storage medium comprising instructions stored thereon that, when executed by at least one processor, are configured to cause a computing system to perform the method of any of Examples 1-21.
Example 23. An apparatus comprising means for performing the method of any of Examples 1-21.
Example 24. An apparatus comprising at least one processor and at least one memory including computer program code, the at least one memory and the computer program code configured to, with the at least one processor, cause the apparatus at least to perform the method of any of Examples 1-21.
Example 25. An apparatus comprising at least one processor and at least one memory storing instructions that, when executed by the at least one processor, cause the apparatus at least to perform the method of any of Examples 1-21.

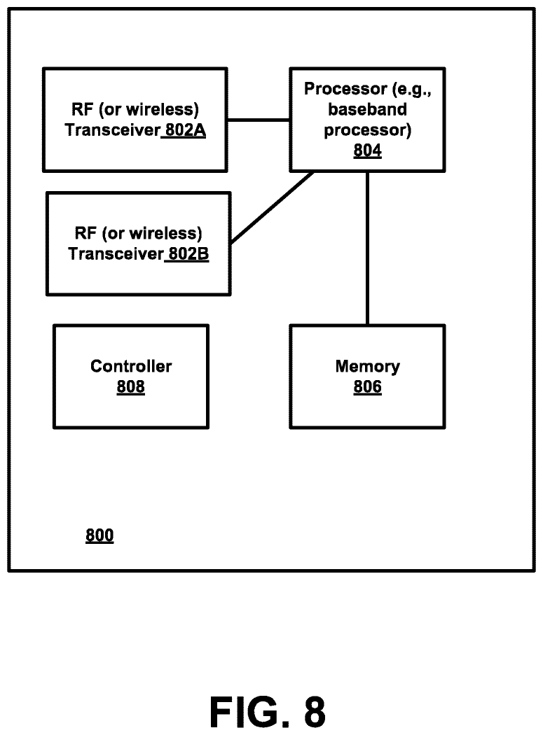

FIG. 8 is a block diagram of a wireless station 800 or wireless node or network node 800 according to an example embodiment. The wireless node or wireless station or network node 800 may include, e.g., one or more of an AP, BS, gNB, RAN node, relay node, UE, terminal device, or user device, network node, network entity, DU, CU-CP, CU-UP, . . . or other node according to an example embodiment.

The wireless station 800 may include, for example, one or more (e.g., two as shown in FIG. 8) radio frequency (RF) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example embodiment, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. Another example of a suitable communications system is the 6G system. It is assumed that network architecture in 6G will be similar to that of the 5G.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-42. (canceled)

43. A method performed by a verification anchor user equipment (UE), the method comprising:
receiving, by the verification anchor UE that is different from a target UE, and from a location management device, a positioning integrity configuration that: identifies one specific sidelink positioning reference signal (SL-PRS) to be validated by a binary selection flag associated with the SL-PRS, and includes a separation tolerance value that defines a minimum time separation for resolving distinct replicas of the SL-PRS in a received energy profile;
measuring, based on the positioning integrity configuration, the identified SL-PRS over a configured measurement occasion to obtain a received energy profile for the identified SL-PRS;
determining that the identified SL-PRS is invalid based on the following being satisfied:
the received energy profile includes at least two peaks separated in time by more than the separation tolerance value;
a time distance between a global power maximum of a first instance of the SL-PRS and a global power maximum of a second instance of the SL-PRS exceeds the separation tolerance;
a time distance between corresponding local maxima of the first instance of the SL-PRS and the second instance of the SL-PRS exceeds the separation tolerance;
a time distance between predefined power-derivative thresholds of the first instance of the SL-PRS and the second instance of the SL-PRS exceeds the separation tolerance;
a measured time of arrival of the first instance of the SL-PRS deviates from an expected time of arrival by more than a configured timing margin; and
a measured peak power of the first instance of the SL-PRS and the second instance of the SL-PRS exceeds a configured power threshold;
based on determining the identified SL-PRS is invalid, declaring an integrity failure for the identified SL-PRS; and
transmitting, to the location management device, an integrity report that includes a one-bit result field indicating the integrity failure for the identified SL-PRS.

44. The method of claim 43, further comprising: determining, based on the received energy profile, whether the measured SL-PRS originates from an expected source anchor UE identified in the positioning integrity configuration.

45. The method of claim 44, wherein the expected time of arrival is calculated as a propagation delay corresponding to a configured distance between a source anchor UE and the verification anchor UE divided by a speed of light value, and further adjusted based on a configured synchronization offset associated with a common reference clock.

46. The method of claim 45, wherein the integrity report comprises an indication of the received energy profile and an outcome of the integrity check associated with the target UE.

47. The method of claim 46, wherein measuring the identified SL-PRS comprises:
measuring a first SL-PRS associated with the source anchor UE; and
measuring a second SL-PRS associated with the source anchor UE during the configured measurement occasion, and wherein the integrity report is generated based on a comparison of the first SL-PRS and the second SL-PRS.

48. The method of claim 47, wherein the second SL-PRS is a replica of the first SL-PRS.

49. The method of claim 48, wherein the location management device is located in a network device, and the method further comprises:
transmitting the integrity report to the network device; and
receiving, from the location management device, a verification report indicating whether the identified SL-PRS is valid.

50. The method of claim 49, further comprising: receiving, from the location management device, an updated assistance data, reconfiguration data for the source anchor UE, and positioning instructions for the target UE.

51. The method of claim 48, wherein the location management device is located in a location server UE, and the method further comprises:
transmitting the integrity report to the location server UE; and
receiving, from the location server UE, a verification report indicating whether the identified SL-PRS is valid.

52. The method of claim 51, wherein the positioning integrity configuration further includes:
(i) an explicit configured distance value between the source anchor UE and the verification anchor UE used to calculate the expected time of arrival;
(ii) a configured synchronization offset relative to a common reference clock shared by the source anchor UE and the verification anchor UE; and
(iii) a configured peak power threshold and a configured timing margin used in the determination that the identified SL-PRS is invalid.

53. A verification anchor user equipment (UE) comprising:
a processor; and
a memory comprising computer-executable instructions that, when executed by the processor, cause the verification anchor UE to perform the following operations:
receiving, by the verification anchor UE that is different from a target UE, and from a location management device, a positioning integrity configuration that: identifies one specific sidelink positioning reference signal (SL-PRS) to be validated by a binary selection flag associated with the SL-PRS, and includes a separation tolerance value that defines a minimum time separation for resolving distinct replicas of the SL-PRS in a received energy profile;
measuring, based on the positioning integrity configuration, the identified SL-PRS over a configured measurement occasion to obtain a received energy profile for the identified SL-PRS;
determining that the identified SL-PRS is invalid based on the following being satisfied:
the received energy profile includes at least two peaks separated in time by more than the separation tolerance value;
a time distance between a global power maximum of a first instance of the SL-PRS and a global power maximum of a second instance of the SL-PRS exceeds the separation tolerance;
a time distance between corresponding local maxima of the first instance of the SL-PRS and the second instance of the SL-PRS exceeds the separation tolerance;
a time distance between predefined power-derivative thresholds of the first instance of the SL-PRS and the second instance of the SL-PRS exceeds the separation tolerance;
a measured time of arrival of the first instance of the SL-PRS deviates from an expected time of arrival by more than a configured timing margin; and
a measured peak power of the first instance of the SL-PRS and the second instance of the SL-PRS exceeds a configured power threshold;
based on determining the identified SL-PRS is invalid, declaring an integrity failure for the identified SL-PRS; and
transmitting, to the location management device, an integrity report that includes a one-bit result field indicating the integrity failure for the identified SL-PRS.

54. The verification anchor UE of claim 53, wherein the operations further comprise: determining, based on the received energy profile, whether the measured SL-PRS originates from an expected source anchor UE identified in the positioning integrity configuration.

55. The verification anchor UE of claim 54, wherein the expected time of arrival is calculated as a propagation delay corresponding to a configured distance between a source anchor UE and the verification anchor UE divided by a speed of light value, and further adjusted based on a configured synchronization offset associated with a common reference clock.

56. The verification anchor UE of claim 55, wherein the integrity report comprises an indication of the received energy profile and an outcome of the integrity check associated with the target UE.

57. The verification anchor UE of claim 56, wherein measuring the identified SL-PRS comprises:
measuring a first SL-PRS associated with the source anchor UE; and
measuring a second SL-PRS associated with the source anchor UE during the configured measurement occasion, and wherein the integrity report is generated based on a comparison of the first SL-PRS and the second SL-PRS.

58. The verification anchor UE of claim 57, wherein the second SL-PRS is a replica of the first SL-PRS.

59. The verification anchor UE of claim 58, wherein the location management device is located in a network device, and wherein the operations further comprise:
transmitting the integrity report to the network device; and
receiving, from the location management device, a verification report indicating whether the identified SL-PRS is valid.

60. The verification anchor UE of claim 59, wherein the operations further comprise:
receiving, from the location management device, an updated assistance data, reconfiguration data for the source anchor UE, and positioning instructions for the target UE.

61. The verification anchor UE of claim 58, wherein the location management device is located in a location server UE, and wherein the operations further comprise:
transmitting the integrity report to the location server UE; and
receiving, from the location server UE, a verification report indicating whether the identified SL-PRS is valid.

62. The verification anchor UE of claim 61, wherein the positioning integrity configuration further includes:
(i) an explicit configured distance value between the source anchor UE and the verification anchor UE used to calculate the expected time of arrival;
(ii) a configured synchronization offset relative to a common reference clock shared by the source anchor UE and the verification anchor UE; and
(iii) a configured peak power threshold and a configured timing margin used in the determination that the identified SL-PRS is invalid.
